(19) United States
(12) Patent Application Publication
(10) Pub. No.: US 2026/0371313 A1
(43) Pub. Date: Nov. 19, 2026

(54) PAGING PROCESSING METHOD AND APPARATUS, TERMINAL, AND NETWORK SIDE DEVICE

(71) Applicant: VIVO MOBILE COMMUNICATION CO., LTD., Dongguan (CN)

(72) Inventors: Dongru LI, Dongguan (CN); Zhipeng LIN, Dongguan (CN)

(21) Appl. No.: 19/735,565

(22) Filed: Jul. 9, 2026

Related U.S. Application Data
(63) Continuation of application No. PCT/CN2025/070302, filed on Jan. 3, 2025.

(30) Foreign Application Priority Data
Jan. 10, 2024 (CN) 202410037656.4

(51) Int. Cl. H04W 68/02; H04L 27/26

(52) U.S. Cl. CPC H04W 68/02; H04L 27/261

(57) ABSTRACT

This application relates to the field of communication technologies, and discloses a paging processing method and apparatus, a terminal, and a network side device. The paging processing method in embodiments of this application includes: A terminal obtains configuration information of a first reference signal. The terminal monitors the first reference signal based on the configuration information of the first reference signal, where the first reference signal is used for at least one of the following: assisting in monitoring paging early indication information; and assisting in monitoring a paging message.

### CROSS-REFERENCE TO RELATED APPLICATIONS

This application is a continuation of International Patent Application No. PCT/CN2025/070302, filed on Jan. 3, 2025, which claims priority to Chinese Patent Application No. 202410037656.4 filed on Jan. 10, 2024, both of which are incorporated herein by reference in their entirety.

### TECHNICAL FIELD

This application relates to the field of communication technologies, and in particular, to a paging processing method and apparatus, a terminal, and a network side device.

### BACKGROUND

In a future communication system, to further reduce network energy consumption, increasing a transmission cycle of a cyclic reference signal is one of key solutions for achieving network energy saving. However, because detection of a communication channel or signal relies on reception of the reference signal, increasing the transmission cycle of the reference signal also causes a delay of channel quality measurement, and affects detection performance of the communication channel or signal such as a paging message, thereby resulting in poor communication reliability.

### SUMMARY

Embodiments of this application provide a paging processing method and apparatus, a terminal, and a network side device.

According to a first aspect, a paging processing method is provided, including:

A terminal obtains configuration information of a first reference signal; and the terminal monitors the first reference signal based on the configuration information of the first reference signal, where
the first reference signal is used for at least one of the following:
assisting in monitoring paging early indication information; and
assisting in monitoring a paging message.

According to a second aspect, a paging processing method is provided, including:

A network side device sends a first reference signal, where the first reference signal is used for at least one of the following:
assisting in monitoring paging early indication information; and
assisting in monitoring a paging message.

According to a third aspect, a paging processing apparatus is provided, including:
an obtaining module, configured to obtain configuration information of a first reference signal; and
a monitoring module, configured to monitor the first reference signal based on the configuration information of the first reference signal, where
the first reference signal is used for at least one of the following:
assisting in monitoring paging early indication information; and
assisting in monitoring a paging message.

According to a fourth aspect, a paging processing apparatus is provided, including: a sending module, configured to send a first reference signal, where the first reference signal is used for at least one of the following: assisting in monitoring paging early indication information; and assisting in monitoring a paging message.

According to a fifth aspect, a terminal is provided. The terminal includes a processor and a memory. The memory stores a program or instructions executable on the processor. The program or the instructions, when executed by the processor, implement the steps of the method according to the first aspect.

According to a sixth aspect, a terminal is provided, including a processor and a communication interface. The communication interface is configured to obtain configuration information of a first reference signal; and monitor the first reference signal based on the configuration information of the first reference signal, where
the first reference signal is used for at least one of the following:
assisting in monitoring paging early indication information; and
assisting in monitoring a paging message.

According to a seventh aspect, a network side device is provided. The network side device includes a processor and a memory. The memory stores a program or instructions executable on the processor. The program or the instructions, when executed by the processor, implement the steps of the method according to the second aspect.

According to an eighth aspect, a network side device is provided, including a processor and a communication interface. The communication interface is configured to send a first reference signal, where
the first reference signal is used for at least one of the following:
assisting in monitoring paging early indication information; and
assisting in monitoring a paging message.

According to a ninth aspect, a readable storage medium is provided. The readable storage medium stores a program or instructions. The program or the instructions, when executed by a processor, implement the steps of the method according to the first aspect, or implement the steps of the method according to the second aspect.

According to a tenth aspect, a wireless communication system is provided, including a terminal and a network side device. The terminal may be configured to perform the steps of the method according to the first aspect. The network side device may be configured to perform the steps of the method according to the second aspect.

According to an eleventh aspect, a chip is provided. The chip includes a processor and a communication interface. The communication interface is coupled to the processor. The processor is configured to run a program or instructions to implement the method according to the first aspect, or implement the method according to the second aspect.

According to a twelfth aspect, a computer program/program product is provided. The computer program/program product is stored in a storage medium. The computer program/program product is executed by at least one processor to implement the method according to the first aspect, or to implement the method according to the second aspect.

### BRIEF DESCRIPTION OF THE DRAWINGS

FIG. 1 is a block diagram of an applicable wireless communication system according to an embodiment of this application;

FIG. 2 is a schematic flowchart of a paging processing method according to an embodiment of this application;

FIG. 3 is an example diagram of an application scenario of a paging processing method according to an embodiment of this application;

FIG. 4 is a schematic flowchart of another paging processing method according to an embodiment of this application;

FIG. 5 is a schematic structural diagram of a paging processing apparatus according to an embodiment of this application;

FIG. 6 is a schematic structural diagram of another paging processing apparatus according to an embodiment of this application;

FIG. 7 is a schematic structural diagram of a communication device according to an embodiment of this application;

FIG. 8 is a schematic structural diagram of a terminal according to an embodiment of this application; and

FIG. 9 is a schematic structural diagram of a network side device according to an embodiment of this application.

### DETAILED DESCRIPTION

Terms “first”, “second”, and the like in this application are used for distinguishing between similar objects rather than describing a specific order or sequence. It should be understood that the terms used in this way may be transposed where appropriate, so that embodiments of this application can be implemented in a sequence other than those illustrated or described herein. In addition, objects defined by “first” and “second” are generally of the same class and do not limit a number of objects. For example, one or more first objects may be provided. In addition, “or” in this application indicates at least one of connected objects. For example, “A or B” encompasses three solutions, that is solution I: A is included but B is not included; solution II: B is included but A is not included; and solution III: both A and B are included. The character “/” generally indicates an “or” relationship between a preceding associated object and a succeeding associated object.

A term “indication” in this application may be a direct indication (or an explicit indication) or an indirect indication (or an implicit indication). The direct indication may be understood as that a sending party clearly informs a receiving party of specific information, a to-be-performed operation, a request result, or the like in a sent indication. The indirect indication may be understood as that the receiving party determines corresponding information based on an indication sent by the sending party, or makes a determination and determines an operation that needs to be performed or a request result based on a determining result.

It should be noted that the technology described in embodiments of this application may be applied to a long term evolution (Long Term Evolution, LTE)/LTE-advanced (LTE-Advanced, LTE-A) system, and may be further applied to another wireless communication system, such as a code division multiple access (Code Division Multiple Access, CDMA) system, a time division multiple access (Time Division Multiple Access, TDMA) system, a frequency division multiple access (Frequency Division Multiple Access, FDMA) system, an orthogonal frequency division multiple access (Orthogonal Frequency Division Multiple Access, OFDMA) system, a single-carrier frequency division multiple access (Single-carrier Frequency Division Multiple Access, SC-FDMA) system, or another system. Terms “system” and “network” in embodiments of this application are usually interchangeably used, and the described technology may be used for both the system and the radio technology mentioned above, or may be used for another system and another radio technology. A new radio (New Radio, NR) system is described below as an example, and the term NR is used in most of the following description. Nevertheless, the technologies may also be applied to a system other than the NR system, such as a sixth generation (6^{th} Generation, 6G) communication system.

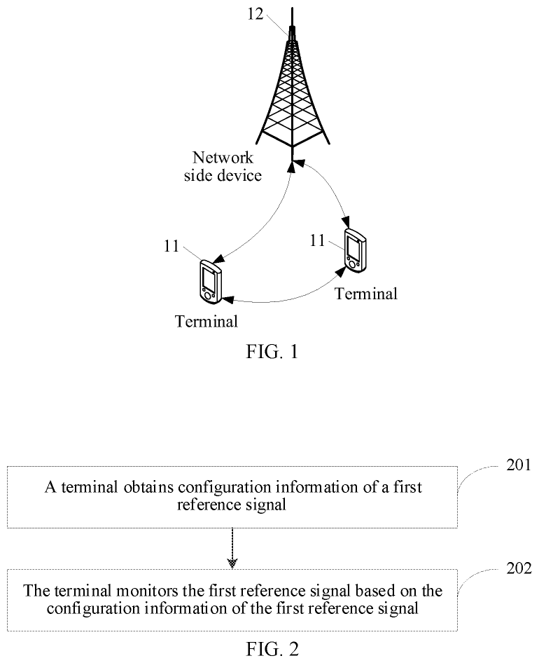

FIG. 1 is a block diagram of an applicable wireless communication system according to an embodiment of this application. The wireless communication system includes a terminal 11 and a network side device 12. The terminal 11 may be a terminal side device such as a mobile phone, a tablet computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile internet device (Mobile Internet Device, MID), an augmented reality (Augmented Reality, AR) device, a virtual reality (Virtual Reality, VR) device, a robot, a wearable device (Wearable Device), a flight vehicle (flight vehicle), a vehicle user equipment (Vehicle User Equipment, VUE), a shipborne device, a pedestrian terminal (Pedestrian User Equipment, PUE), a smart home appliance (a home device with a wireless communication capability, such as a refrigerator, a television, a washing machine, or furniture), a game console, a personal computer (Personal Computer, PC), a teller machine, or a self-service machine. The wearable device includes a smart watch, a smart bracelet, a smart headset, smart glasses, smart jewelry (a smart bangle, a smart chain bracelet, a smart ring, a smart necklace, a smart ankle bangle, a smart ankle chain bracelet, and the like), a smart wristband, smart clothing, and the like. The vehicle user equipment may also be referred to as an on-board terminal, an on-board controller, an on-board module, an on-board component, an on-board chip, an on-board unit, or the like. It should be noted that a specific type of the terminal 11 is not limited in embodiments of this application. The network side device 12 may include an access network device or a core network device. The access network device may also be referred to as a radio access network (Radio Access Network, RAN) device, a wireless access network function, or a wireless access network unit. The access network device may include a base station, a wireless local area network (Wireless Local Area Network, WLAN) access point (Access Point, AP), a wireless fidelity (Wireless Fidelity, Wi-Fi) node, or the like. The base station may be referred to as a Node B (Node B, NB), an evolved Node B (Evolved Node B, eNB), a next generation Node B (the next generation Node B, gNB), a new radio Node B (New Radio Node B, NR Node B), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home Node B (home Node B, HNB), a home evolved Node B (home evolved Node B), a transmission reception point (Transmission Reception Point, TRP), or another appropriate term in the art. The base station is not limited to a specific technology vocabulary, provided that the same technical effects are achieved. It should be noted that, in embodiments of this application, only a base station in an NR system is used as an example for description, and a specific type of the base station is not limited.

For ease of understanding, some contents in embodiments of this application are described below.

A terminal in an idle (idle) mode needs to perform radio resource management (Radio Resource Management, RRM) measurement and monitoring of paging physical downlink control channel (Physical Downlink Control Channel, PDCCH) in each paging cycle. The PDCCH is a PDCCH on which a paging-radio network temporary identifier (P-RNTI) is used to perform cyclic redundancy check (Cyclic redundancy check, CRC) scrambling. The terminal receives a corresponding paging physical downlink shared channel (Physical downlink shared channel, PDSCH) based on scheduling of the detected paging PDCCH. However, because a paging probability of a terminal in one paging occasion (paging occasion, PO) group (group) is generally approximately 10%, the terminal does not receive paging thereof in approximately 90% of cases (case). Therefore, 90% of paging monitoring power consumption is wasted.

To reduce power consumption of the terminal, paging early indication (Paging Early Indication, PEI) information is introduced. The terminal receives the PEI before receiving a physical downlink control channel (Physical downlink control channel, PDCCH). The terminal determines in advance whether a subsequent paging PDCCH needs to be monitored based on an indication in the PEI. If the PEI indicates a UE not to monitor the paging, the terminal may skip reception of one or more SSBs before the paging and skip reception of the paging PDCCH or the paging PDSCH, thereby reducing power consumption.

If a future communication system, such as 6G, uses an SSB design with a large cycle, the terminal does not have sufficient SSB monitoring opportunities to support paging monitoring, thereby resulting in poor paging reliability. Therefore, a paging processing method of this application is provided, which can resolve a problem of poor communication reliability caused by a synchronization signal block (Synchronization Signal block, SSB) design with a large cycle.

It should be noted that in the future communication system, the SSB may be replaced with another signal having a function similar to that of the SSB. In the following embodiments, the SSB representing a reference signal having at least one function such as synchronization, cell search, cell access, cell selection, channel measurement, and mobility measurement is used for description.

A paging processing method provided in embodiments of this application is described in detail below through some embodiments and application scenarios thereof with reference to the accompanying drawings.

Refer to FIG. 2. Embodiments of this application provide a paging processing method. As shown in FIG. 2, the paging processing method includes the following steps.

Step 201: A terminal obtains configuration information of a first reference signal.

Step 202: The terminal monitors the first reference signal based on the configuration information of the first reference signal, where
the first reference signal is used for at least one of the following:
assisting in monitoring paging early indication information; and
assisting in monitoring a paging message.

It may be understood that the foregoing assisting may be understood as or replaced with helping or being used for.

It may be understood that the foregoing monitoring may be understood as or replaced with detecting, receiving, supervising, or the like.

In embodiments of this application, at least one of the related information used for demodulating the paging early indication information and the related information used for demodulating the paging message may be obtained based on monitoring and detection of the first reference signal. In this way, the related information sufficient for supporting demodulation of the paging message and the paging early indication information can still be obtained when no sufficient SSBs exist, thereby ensuring that the terminal can demodulate the paging early indication information and the paging message, and improving paging reliability.

Optionally, in some embodiments, the foregoing first reference signal may include at least one of the following: an SSB, a secondary synchronization signal (Secondary Synchronization Signal, SSS), a primary synchronization signal (Primary Synchronization Signal, PSS), a tracking reference signal (tracking reference signal, TRS), and a channel state information reference signal (Channel State Information reference signal, CSI-RS).

In some embodiments, the network side device may configure two or more sets of reference signal configurations. Information of one set of the reference signal configurations is the configuration information of the first reference signal. It may be understood that the network side device configures a set of first reference signal configurations associated with paging message monitoring. Optionally, the first reference signal may be a cyclic reference signal, or may be an acyclic reference signal. Further, the network side device indicates whether the foregoing first reference signal configuration is enabled through PEI or a paging indication. In other words, the network side device may enable the foregoing first reference signal configuration through a dynamic indication. In another embodiment, the configuration information of the first reference signal is configured through high layer configuration and PEI or a paging indication. For example, partial configuration information of the first reference signal (such as other configuration information except time domain configuration) is configured through high layer configuration, and time domain configuration information of the first reference signal is configured through PEI or a paging indication. For example, a paging PDCCH or PEI indicates a monitoring occasion of the first reference signal by indicating a time offset of the first reference signal. For example, description is provided by using the first reference signal being an SSB as an example.

In an embodiment, partial configuration information of the first reference signal may share same parameter configuration with the second reference signal or another reference signal other than the first reference signal. For example, the first reference signal is an SSB, and the second reference signal is also an SSB. The two SSBs share same partial configuration information. For another example, the two SSBs are respectively configured with their own time-frequency domain position information, and the time-frequency domain position information of the two SSBs is different or independently configured.

In some embodiments, the network side device may configure two sets of SSB configuration information for the terminal through high layer signaling, where a first set of SSB configuration information may be understood as at least partial information of the configuration information of the first reference signal, and a second set of SSB configuration information may be understood as cyclic SSB configuration information defined in a current protocol. Optionally, the network side device may carry information indicating whether the first set of SSB configuration information is enabled by PEI, a paging message, or high layer signaling, to indicate whether the first reference signal is enabled. The information indicating whether the first set of SSB configuration information is enabled and carried in the PEI or the high layer signaling may also be understood as the configuration information of the first reference signal.

In some embodiments, the network side device may configure one set of SSB configuration information for the terminal through high layer signaling, such as cyclic SSB configuration information defined in an existing protocol. The network side device may carry time domain configuration information of an SSB in PEI, and the time domain configuration information of the SSB is combined with partial configuration information in the cyclic SSB configuration information defined in the protocol (for example, other configuration information of the SSB except time domain configuration) to obtain the configuration information of the first reference signal.

It may be understood that the paging message includes at least one of a paging PDCCH and a paging PDSCH.

In embodiments of this application, the terminal obtains the configuration information of the first reference signal; and the terminal monitors the first reference signal based on the configuration information of the first reference signal, where the first reference signal is used for at least one of the following: assisting in monitoring paging early indication information; and assisting in monitoring a paging message. Because the first reference signal assists in at least one of monitoring of the paging early indication information and monitoring of the paging message, this can avoid a case in which an excessively large SSB cycle makes it impossible to support demodulation of the paging early indication information and the paging message. Therefore, embodiments of this application improve communication reliability.

Optionally, in some embodiments, the first reference signal is further used for at least one of the following: mobility measurement; cell selection; selection of a random access resource; switching of a transmission reception point TRP; switching of a TRP group; beam failure detection; beam management; link failure detection; positioning; activation of another reference signal or channel; deactivation of another reference signal or channel; path loss estimation; power control; and power distribution.

In embodiments of this application, the terminal may perform at least one of the following based on monitoring of the first reference signal: mobility measurement; cell selection; selection of a random access resource; switching of a transmission reception point TRP; switching of a TRP group; beam failure detection; beam management; link failure detection; positioning; activation of another reference signal or channel; deactivation of another reference signal or channel; path loss estimation; power control; and power distribution. In this way, a plurality of different functions may be implemented through the first reference signal, thereby reducing resource overheads.

It should be noted that when the first reference signal is used for selection of a random access resource, the random access resource may be configured to be associated with the first reference signal.

Optionally, in some embodiments, the configuration information of the first reference signal includes information indicating whether the first reference signal is enabled, and that the terminal monitors the first reference signal based on the configuration information of the first reference signal includes:

The terminal monitors the first reference signal based on the configuration information of the first reference signal when the first reference signal is enabled.

In embodiments of this application, because the information indicating whether the first reference signal is enabled is configured in the configuration information of the first reference signal, the first reference signal may be flexibly enabled based on a time requirement, thereby improving flexibility of the monitoring of the first reference signal. For example, in some embodiments, after sending the configuration information of the first reference signal, the network side device may enable or disable the first reference signal through a subsequent dynamic indication.

Optionally, the foregoing whether the first reference signal is enabled may be understood as or replaced with whether the first reference signal can be used, and may also be understood as whether the first reference signal is activated or deactivated.

Optionally, in some embodiments, a first monitoring occasion of the first reference signal satisfies at least one of the following:
the first monitoring occasion is located before a second monitoring occasion of the paging early indication information, and a time interval between the first monitoring occasion and the second monitoring occasion is less than or equal to a first time interval;
the first monitoring occasion is located between the second monitoring occasion of the paging early indication information and a paging occasion associated with the paging early indication information;
the first monitoring occasion is located after the second monitoring occasion of the paging early indication information, and a time interval between the first monitoring occasion and the second monitoring occasion is less than or equal to a second time interval;
the first monitoring occasion is located after the second monitoring occasion of the paging early indication information, and a time interval between the first monitoring occasion and the second monitoring occasion is larger than a third time interval; and
the first monitoring occasion is located before the paging occasion, and a time interval between the first monitoring occasion and the paging occasion is less than or equal to a fourth time interval.

In embodiments of this application, the first reference signal corresponding to the first monitoring occasion which is located before the second monitoring occasion of the paging early indication information may be used for assisting in at least one of the following: monitoring of current paging early indication information and monitoring of a paging message on a paging occasion associated with the current paging early indication information.

The first reference signal corresponding to the first monitoring occasion located between the second monitoring occasion of the paging early indication information and the paging occasion associated with the paging early indication information may be used for assisting in at least one of the following: monitoring of a paging message on a paging occasion associated with the current paging early indication information and monitoring of next paging early indication information.

The first reference signal corresponding to the first monitoring occasion that is located after the second monitoring occasion of the paging early indication information and that has a time interval from the second monitoring occasion less than or equal to a second time interval may be used for assisting in at least one of the following: monitoring of a paging message on a paging occasion associated with the current paging early indication information and monitoring of the next paging early indication information.

The first reference signal corresponding to the first monitoring occasion that is located before the paging occasion and that has an interval from the paging occasion less than or equal to a fourth time interval may be used for assisting in at least one of the following: monitoring of a paging message on a paging occasion associated with the current paging early indication information and monitoring of the next paging early indication information.

Optionally, when the paging early indication information is associated with a plurality of paging occasions, the foregoing position relationship between the first monitoring occasion and the paging occasion may be understood as a position relationship between the first monitoring occasion and a first paging occasion associated with the paging early indication information, where the first paging occasion is a paging occasion closest to the paging early indication information. For example, that the first monitoring occasion of the first reference signal is located before the paging occasion may be understood as the first monitoring occasion of the first reference signal is located before the first paging occasion associated with the paging early indication information.

Optionally, in some embodiments, the first reference signal satisfies at least one of the following:
a structure of the first reference signal is at least partially consistent with a structure of a second reference signal; and
relative position relationships of time-frequency resources of components of the first reference signal are at least partially consistent with relative position relationships of time-frequency resources of components of the second reference signal, where
the second reference signal includes a synchronization signal block SSB or a tracking reference signal TRS.

For example, the first reference signal is an SSS.

Optionally, in some embodiments, the configuration information of the first reference signal includes at least one of the following:
a signal type of the first reference signal;
an association relationship between the first reference signal and the second reference signal;
time-frequency domain position information of the first reference signal;
offset information of the first monitoring occasion of the first reference signal, where the offset information is used for representing offset information of the first monitoring occasion relative to a target occasion, and the target occasion includes the paging occasion or the second monitoring occasion of the paging early indication information;
port information of the first reference signal;
a resource list of the first reference signal;
a repetition number of the first reference signal;
an effective delay of the first reference signal;
a transmission cycle of the first reference signal; and
an activation state of the first reference signal, where the activation state includes activation or deactivation.

In embodiments of this application, the foregoing another reference signal may be an SSB. The foregoing association relationship may include a quasi co-location (Quasi co-location, QCL) association relationship, and types of the quasi co-location include C and D. For example, a first reference signal index1 is associated with an SSB index1, and a QCL-TypeD relationship exists therebetween.

According to a 3GPP specification 38.214 5.1.5, QCL has the following four types, which are respectively QCL-TypeA, QCL-TypeB, QCL-TypeC, and QCL-TypeD. The four types indicate which large-scale channel properties are common in an antenna port group.
‘QCL-TypeA’: {Doppler shift, Doppler spread, average delay, delay spread};
‘QCL-TypeB’: {Doppler shift, Doppler spread};
‘QCL-TypeC’: {Doppler shift, average delay}; and
‘QCL-TypeD’: {Spatial Rx parameter}.

Doppler shift (Doppler Shift): The Doppler shift is a frequency change of a radio signal relative to movement of a receiver. For example, a gNB transmits a radio signal with a frequency of “X”. However, a receiver (a UE) is moving away from the gNB, so that a frequency of the same radio signal generated by a distance when arriving at the UE (due to transmission time) is changed to “Y”. This phenomenon is referred to as the Doppler shift. An example in real life is a sound emitted when a speeding train approaches a platform, and makes a person standing on the platform accelerate away. This is the Doppler shift of a sound wave.

Doppler spread (Doppler Spread): The Doppler spread is referred to as a fading rate, and a difference of signal frequencies at Tx and Rx relative to time is referred to as the Doppler spread. For example, a rate at which a train sound changes with time is referred to as the Doppler spread.

The average delay (Average Delay): When a signal is transmitted from a plurality of antennas, the signal arrives at a receiver through multipath reflection of surrounding clutter. In a multipath solution, an average time used for receiving all multipath components at the receiver is referred to as the average delay.

Delay spread (Delay Spread): A difference between an arrival time of an earliest valid multipath component (such as a usual line-of-sight component) and an arrival time of a last multipath component is referred to as the delay spread.

Spatial receiver parameter (Spatial Receiver Parameter): The spatial receiver parameter refers to a beamforming property of a downlink received signal, such as a main angle of arrival or an average angle of arrival.

Optionally, the time-frequency domain position information of the first reference signal may include a starting position or a relative offset in time domain or frequency domain where the first reference signal is located, and a size of a time-frequency domain resource where the first reference signal is located. Alternatively, the time-frequency domain position information of the first reference signal may include a time-frequency domain pattern of the first reference signal.

Optionally, the foregoing resource list may include one or more first reference signal resources configured with the foregoing configuration information.

Optionally, the network side device may flexibly indicate configuration or activation of the first reference signal having some of the foregoing parameter properties.

Optionally, the foregoing repetition number may be understood as a repetition number in one transmission opportunity.

Optionally, in some embodiments, a method of obtaining the configuration information of the first reference signal includes at least one of the following:
configured by high layer information of a network side device;
specified by a protocol; and
indicated by physical layer signaling or a signal.

Optionally, the foregoing physical layer signaling or signal may include the paging early indication information or the paging PDCCH.

Optionally, the configuration information of the first reference signal may be carried by multilevel signaling. For example, the configuration information of the first reference signal is configured by high layer information of the network side device, but activation and deactivation of the first reference signal are carried by layer 1 signaling. For another example, the configuration information of the first reference signal is predefined in a protocol, but activation and deactivation of the first reference signal are carried by the layer 1 signaling.

Optionally, in some embodiments, the paging early indication information or the paging message includes target indication information, and the target indication information is used for indicating at least one of the following:
the activation state of the first reference signal;
the offset information of the first monitoring occasion of the first reference signal; and
the repetition number of the first reference signal.

In embodiments of this application, activating or deactivating one or more first reference signals or one or more groups of first reference signals may be indicated by a bitstring (bitstring) or a bitmap (bitmap). Each group of first reference signals has different features or configurations.

Optionally, when an offset value of the foregoing offset information is a specific value, it may be considered that the first reference signal is disabled, unavailable, or deactivated.

Optionally, in some embodiments, the target indication information included in the paging early indication information is applied to the monitoring of a paging message associated with the paging early indication information. In this way, specificity of the indication of the target indication information can be improved, so that the first reference signal can be flexibly used to assist in monitoring the paging message. For example, when a sufficient number of SSBs exist between the second monitoring occasion of the paging early indication information and the paging occasion associated with the paging early indication information, the first reference signal may be disabled, thereby saving power of the terminal and resource overheads. Therefore, in embodiments of this application, resource overheads can be saved while reliability of paging monitoring is ensured.

Optionally, in some embodiments, the method further includes:

The terminal determines not to monitor the first reference signal at the first monitoring occasion of the first reference signal when a second preset condition is satisfied, where
the second preset condition includes at least one of the following:
the paging early indication information indicates not to monitor the paging message; and
the second reference signal between the second monitoring occasion of the paging early indication information and the paging occasion of the paging message associated with the paging early indication information satisfies the first preset condition, where
the first preset condition includes at least one of the following: the number of the second reference signals is greater than the first preset threshold; and a number of second reference signals with measured values being greater than or equal to the second preset threshold is greater than the third preset threshold.

In embodiments of this application, under the second preset condition, the terminal does not monitor the first reference signal at the first monitoring occasion of the first reference signal, thereby avoiding ineffective monitoring or unnecessary monitoring of the first reference signal, and saving power of the terminal.

Optionally, in some embodiments, the first reference signal is a repeated transmission of the second reference signal. In embodiments of this application, the second reference signal may be a cyclic reference signal, for example, may be an SSB or an SSB defined in a cell.

Optionally, the first reference signal may be repeatedly transmitted with reference to the nearest cyclic SSB transmission as a copy.

It should be understood that, when the first reference signal is a repeated transmission of the SSB, the configuration information of the first reference signal may include only the time-domain position information of the repeated transmission of the SSB. In this case, content of the configuration information of the first reference signal that needs to be agreed on by the network side device or in the protocol may be greatly reduced, thereby reducing complexity of the protocol.

Optionally, in some embodiments, the paging early indication information is carried by downlink control information DCI or a low-power wake-up signal LP-WUS.

Optionally, the low-power wake-up signal is received by a low-power wake-up receiver (LP-WUR).

For better understanding of this application, description is provided below through some examples.

A scenario of application of the first reference signal is as follows. The network side device configures a cyclic SSB with a very large cycle, so that a time interval between monitoring of paging early indication information or the paging occasion and an SSB occasion is very large, and the terminal needs to wake up frequently for monitoring, and cannot directly enter deep sleep after continuously monitoring all content, thereby resulting in increased power consumption of the terminal. In addition, if the terminal does not have sufficient SSB monitoring between the paging early indication information and the paging occasion, the terminal may fail to correctly demodulate paging information, resulting in degraded communication performance.

To resolve this problem, the network side device may configure the first reference signal to supplement a scenario in which SSB monitoring occasions are insufficient, or to reduce a distance between the reference signal and monitoring of the paging early indication information or the paging occasion, to achieve an effect of energy saving of the terminal.

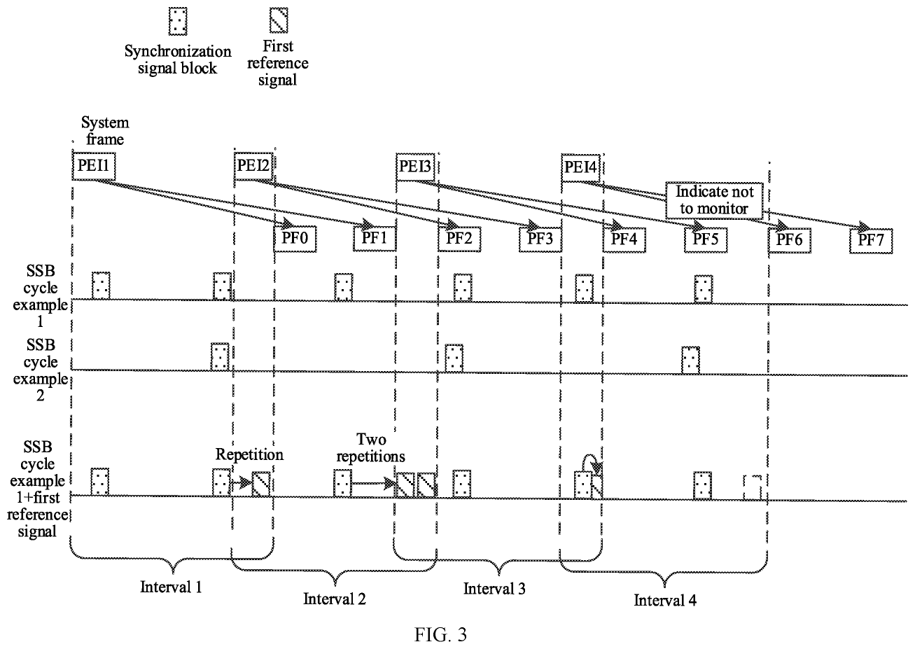

In an example, as shown in FIG. 3, one paging early indication is associated with and indicates (an association relationship is represented by an arrow) all POs in two paging frames. Using an SSB cycle example 1 as an example, two SSB monitoring occasions exist in an interval 1 between the paging early indication information and the associated paging occasion (which is shown at a paging-frame (paging frame, PF) granularity in the figure, and one paging frame includes 4 POs), only 1 SSB exists in an interval 2, 2 SSBs exist in an interval 3, and 1 SSB exists in an interval 4. Using an SSB cycle example 2 as an example, the SSB cycle is increased, 1 SSB monitoring occasion exists in the interval 1, no SSB exists in the interval 2, 1 SSB exists in the interval 3, and no SSB exists in the interval 4. In this case, for a terminal in poor coverage, monitoring of only cyclic SSBs is insufficient to support demodulation of paging information. Therefore, in this embodiment, the network side device configures the first reference signal, as shown in FIG. 3.

Using an SSB cycle example 1 as an example, an occasion of the first reference signal is located before a paging occasion, but is not before each paging occasion. As shown in FIG. 3, the occasions of the first reference signal are located before a PF0, a PF2, a PF4, and a PF6.

In an example, the first reference signal is a repeated transmission of partial or all content of an SSB.

In an example, the first reference signal is a repeated transmission of an SSS in an SSB. As shown in FIG. 3, the SSS is a repetition of an SSS in the nearest cyclic SSB transmission.

Optionally, the paging early indication information indicates at least one of the following: a monitoring position or a sending position of the first reference signal; and a repetition number of the first reference signal.

In an example, the indication of the paging early indication information on the first reference signal is applied to the monitoring of a paging occasion associated with the paging early indication information.

In an example, related parameters of the first reference signal including the monitoring occasion of the first reference signal are configured by the network side device.

In an example, the configuration information of the first reference signal is configured by a network, but the monitoring occasion of the first reference signal is dynamically indicated by the paging early indication information or the paging information.

In an example, the type of the first reference signal may be at least one of an SSB, an SSS, a PSS, a TRS, and a CSI-RS.

In an example, when the paging early indication information indicates not to monitor paging, the terminal does not monitor the first reference signal at the first monitoring occasion of the first reference signal. For example, as shown in FIG. 3, if paging early indication information 4 indicates that the terminal is not to monitor the paging occasion, the terminal does not need to monitor the first reference signal, thereby not monitoring at the monitoring occasion (as the monitoring occasion corresponding to the dashed box in FIG. 3) of the first reference signal within the interval 4. When terminals associated with PF6 and PF7 have no paging requirement, the network side device may not send the first reference signal before the PF6.

In some embodiments, when the paging early indication information indicates not to monitor paging, the network side device does not indicate the first reference signal to the terminal. To be specific, the network side device does not activate the first reference signal associated with the paging occasion. Actually, on the premise that the network sends an SSB (a second reference signal) with a large transmission cycle, although it is further necessary to consider additionally sending the first reference signal to satisfy requirements of the terminal for monitoring and detecting the paging message, because a probability that a terminal associated with one paging occasion is paged is very low, for example, 10%, a probability that the network side additionally sends the first reference signal is also very low. Therefore, in the other 90% of cases, the network side device can still obtain a network energy saving gain by sending the SSB with the large transmission cycle.

It should be noted that, in an embodiment, the first reference signal is an additionally sent reference signal on top of sending the second reference signal (for example, the second reference signal is a cyclic SSB and the SSB transmission cycle is long) by the network side device.

In an example, the network side device may configure or indicate the occasion information of the first reference signal for the first time through the paging early indication or the paging information. For example, the network side device configures or dynamically indicates an offset of the first reference signal relative to the paging early indication information or relative to the paging frame or the paging occasion.

In an example, when the paging early indication information is associated with a plurality of paging occasions (as shown in FIG. 3, one paging early indication information associates with and indicates all POs in two paging frames), the network side device configures or dynamically indicates the offset of the first reference signal relative to the first paging frame or the paging occasion among the paging frames or the paging occasions associated with the paging early indication information. For example, in FIG. 3, the occasion of the first reference signal is configured relative to a PF0, a PF2, a PF4, and a PF6. The PF0, the PF2, the PF4, and the PF6 are the first PF associated with each paging early indication.

Optionally, a type of the paging early indication information may be the DCI or the LP-WUS.

In an example, the paging early indication information is the LP-WUS. The position of the first reference signal is configured relative to the LP-WUS. For example, the first reference signal occasion is located at a position spaced apart from the LP-WUS by a specific time interval after the LP-WUS. Optionally, the specific time interval is related to a wake-up conversion delay.

Optionally, a plurality of sets of first reference signal resources or resource sets may be configured. The configuration information of the first reference signal in each of the sets of first reference signal resources or resource sets may be configured independently, and may be the same or different. For example, a total of 4 sets of first reference signal resource sets are provided, and the first reference signal resources in each of the sets of first reference signal resource sets have a same configuration.

Optionally, the configuration information of the first reference signal includes at least one of the following:
a signal type of the first reference signal;
an association relationship between the first reference signal and an SSB;
time-frequency domain position information of the first reference signal;
offset information of the first monitoring occasion of the first reference signal, where the offset information is used for representing offset information of the first monitoring occasion relative to a target occasion, and the target occasion includes the paging occasion or the second monitoring occasion of the paging early indication information;
port information of the first reference signal;
a resource list of the first reference signal;
a repetition number of the first reference signal;
an effective delay of the first reference signal;
a transmission cycle of the first reference signal; and
an activation state of the first reference signal, where the activation state includes activation or deactivation.

In the foregoing association relationship between the first reference signal and the SSB, different first reference signal resource sets may be associated with a same SSB index. The numbers of first reference signal resource sets associated with different SSB indexes may be the same or different.

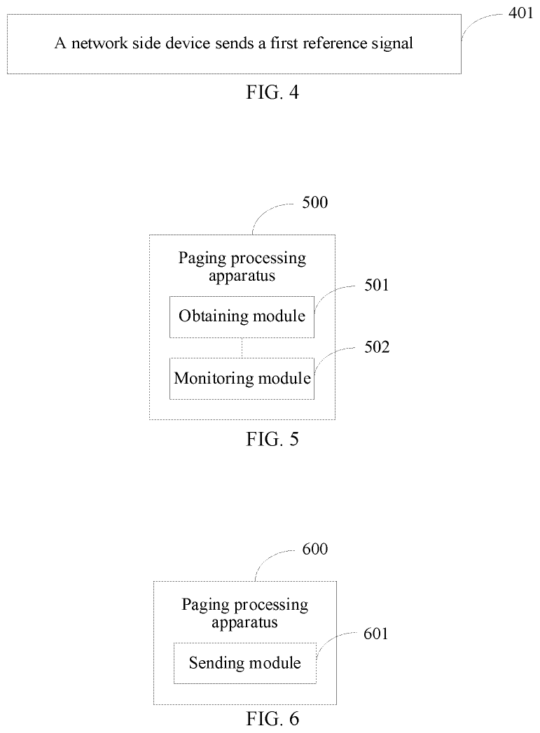

Referring to FIG. 4, embodiments of this application further provide a paging processing method. As shown in FIG. 4, the paging processing method includes:

Step 401: A network side device sends a first reference signal, where the first reference signal is used for at least one of the following: assisting in monitoring paging early indication information; and assisting in monitoring a paging message.

Optionally, that a network side device sends a first reference signal includes:

The network side device sends the first reference signal when a second reference signal between a second monitoring occasion corresponding to the paging early indication information and a paging occasion associated with the paging early indication information satisfies a first preset condition.

Optionally, the method further includes:

The network side device sends configuration information of the first reference signal to a terminal.

Optionally, the first reference signal is further used for at least one of the following:
mobility measurement; cell selection; selection of a random access resource; switching of a transmission reception point TRP; switching of a TRP group; beam failure detection; beam management; link failure detection; positioning; activation of another reference signal or channel; deactivation of another reference signal or channel; path loss estimation; power control; and power distribution.

Optionally, the configuration information of the first reference signal includes information indicating whether the first reference signal is enabled.

Optionally, the first reference signal satisfies at least one of the following:
a structure of the first reference signal is at least partially consistent with a structure of a second reference signal; and
relative position relationships of time-frequency resources of components of the first reference signal are at least partially consistent with relative position relationships of time-frequency resources of components of the second reference signal, where
the second reference signal includes a synchronization signal block SSB or a tracking reference signal TRS.

Optionally, the configuration information of the first reference signal includes at least one of the following:
a signal type of the first reference signal;
an association relationship between the first reference signal and the second reference signal;
time-frequency domain position information of the first reference signal;
offset information of the first monitoring occasion of the first reference signal, where the offset information is used for representing offset information of the first monitoring occasion relative to a target occasion, and the target occasion includes the paging occasion or the second monitoring occasion of the paging early indication information;
port information of the first reference signal;
a resource list of the first reference signal;
a repetition number of the first reference signal;
an effective delay of the first reference signal;
a transmission cycle of the first reference signal; and
an activation state of the first reference signal, where the activation state includes activation or deactivation.

Optionally, the paging early indication information or the paging message includes target indication information, and the target indication information is used for indicating at least one of the following:
the activation state of the first reference signal;
the offset information of the first monitoring occasion of the first reference signal; and
the repetition number of the first reference signal.

Optionally, the target indication information included in the paging early indication information is applied to the monitoring of a paging message associated with the paging early indication information.

Optionally, the first reference signal is a repeated transmission of the second reference signal.

Optionally, the paging early indication information is carried by downlink control information (Downlink Control Information, DCI) or a low-power wake-up signal (Low-Power Wake-Up Signal, LP-WUS).

The paging processing method provided in embodiments of this application may be performed by a paging processing apparatus. In embodiments of this application, the paging processing apparatus provided in embodiments of this application is described by using an example in which the paging processing apparatus performs the paging processing method.

Referring to FIG. 5, embodiments of this application further provide a paging processing apparatus. As shown in FIG. 5, the paging processing apparatus 500 includes:
an obtaining module 501, configured to obtain configuration information of a first reference signal; and
a monitoring module 502, configured to monitor the first reference signal based on the configuration information of the first reference signal, where
the first reference signal is used for at least one of the following:
assisting in monitoring paging early indication information; and
assisting in monitoring a paging message.

Optionally, the first reference signal is further used for at least one of the following:
mobility measurement; cell selection; selection of a random access resource; switching of a transmission reception point TRP; switching of a TRP group; beam failure detection; beam management; link failure detection; positioning; activation of another reference signal or channel; deactivation of another reference signal or channel; path loss estimation; power control; and power distribution.

Optionally, the configuration information of the first reference signal includes information indicating whether the first reference signal is enabled, and the monitoring module 502 is specifically configured to monitor the first reference signal based on the configuration information of the first reference signal when the first reference signal is enabled.

Optionally, a first monitoring occasion of the first reference signal satisfies at least one of the following:
the first monitoring occasion is located before a second monitoring occasion of the paging early indication information, and a time interval between the first monitoring occasion and the second monitoring occasion is less than or equal to a first time interval;
the first monitoring occasion is located between the second monitoring occasion of the paging early indication information and a paging occasion associated with the paging early indication information;
the first monitoring occasion is located after the second monitoring occasion of the paging early indication information, and a time interval between the first monitoring occasion and the second monitoring occasion is less than or equal to a second time interval;
the first monitoring occasion is located after the second monitoring occasion of the paging early indication information, and a time interval between the first monitoring occasion and the second monitoring occasion is larger than a third time interval; and
the first monitoring occasion is located before the paging occasion, and a time interval between the first monitoring occasion and the paging occasion is less than or equal to a fourth time interval.

Optionally, the first reference signal satisfies at least one of the following:
a structure of the first reference signal is at least partially consistent with a structure of a second reference signal; and
relative position relationships of time-frequency resources of components of the first reference signal are at least partially consistent with relative position relationships of time-frequency resources of components of the second reference signal, where
the second reference signal includes a synchronization signal block SSB or a tracking reference signal TRS.

Optionally, the configuration information of the first reference signal includes at least one of the following:
a signal type of the first reference signal;
an association relationship between the first reference signal and the second reference signal;
time-frequency domain position information of the first reference signal;
offset information of the first monitoring occasion of the first reference signal, where the offset information is used for representing offset information of the first monitoring occasion relative to a target occasion, and the target occasion includes the paging occasion or the second monitoring occasion of the paging early indication information;
port information of the first reference signal;
a resource list of the first reference signal;
a repetition number of the first reference signal;
an effective delay of the first reference signal;
a transmission cycle of the first reference signal; and
an activation state of the first reference signal, where the activation state includes activation or deactivation.

Optionally, a method of obtaining the configuration information of the first reference signal includes at least one of the following:
configured by high layer information of a network side device;
specified by a protocol; and
indicated by physical layer signaling or a signal.

Optionally, the paging early indication information or the paging message includes target indication information, and the target indication information is used for indicating at least one of the following:
the activation state of the first reference signal;
the offset information of the first monitoring occasion of the first reference signal; and
the repetition number of the first reference signal.

Optionally, the target indication information included in the paging early indication information is applied to the monitoring of a paging message associated with the paging early indication information.

Optionally, the monitoring module 502 is specifically configured to monitor the first reference signal based on the configuration information of the first reference signal when the second reference signal between the second monitoring occasion of the paging early indication information and the paging occasion of the paging message associated with the paging early indication information satisfies a first preset condition, where
the first preset condition includes at least one of the following:
a number of second reference signals is less than or equal to a first preset threshold; and
a number of second reference signals with measured values being greater than or equal to a second preset threshold is less than or equal to a third preset threshold.

Optionally, the paging processing apparatus 500 further includes a determining module, configured to determine not to monitor the first reference signal on the first monitoring occasion of the first reference signal when a second preset condition is satisfied, where
the second preset condition includes at least one of the following:
the paging early indication information indicates not to monitor the paging message; and
the second reference signal between the second monitoring occasion of the paging early indication information and the paging occasion of the paging message associated with the paging early indication information satisfies the first preset condition, where
the first preset condition includes at least one of the following: the number of the second reference signals is greater than the first preset threshold; and a number of second reference signals with measured values being greater than or equal to the second preset threshold is greater than the third preset threshold.

Optionally, the first reference signal is a repeated transmission of the second reference signal.

Optionally, the paging early indication information is carried by downlink control information DCI or a low-power wake-up signal LP-WUS.

Referring to FIG. 6, embodiments of this application further provide a paging processing apparatus. As shown in FIG. 6, the paging processing apparatus 600 includes:
a sending module 601, configured to send a first reference signal, where
the first reference signal is used for at least one of the following:
assisting in monitoring paging early indication information; and
assisting in monitoring a paging message.

Optionally, the sending module 601 is specifically configured to send the first reference signal when a second reference signal between a second monitoring occasion corresponding to the paging early indication information and a paging occasion associated with the paging early indication information satisfies a first preset condition.

Optionally, the sending module 601 is further configured to send configuration information of the first reference signal to a terminal.

Optionally, the first reference signal is further used for at least one of the following:
mobility measurement; cell selection; selection of a random access resource; switching of a transmission reception point TRP; switching of a TRP group; beam failure detection; beam management; link failure detection; positioning; activation of another reference signal or channel; deactivation of another reference signal or channel; path loss estimation; power control; and power distribution.

Optionally, the configuration information of the first reference signal includes information indicating whether the first reference signal is enabled.

Optionally, the first reference signal satisfies at least one of the following:
a structure of the first reference signal is at least partially consistent with a structure of a second reference signal; and
relative position relationships of time-frequency resources of components of the first reference signal are at least partially consistent with relative position relationships of time-frequency resources of components of the second reference signal, where
the second reference signal includes a synchronization signal block SSB or a tracking reference signal TRS.

Optionally, the configuration information of the first reference signal includes at least one of the following:
a signal type of the first reference signal;
an association relationship between the first reference signal and the second reference signal;
time-frequency domain position information of the first reference signal;
offset information of the first monitoring occasion of the first reference signal, where the offset information is used for representing offset information of the first monitoring occasion relative to a target occasion, and the target occasion includes the paging occasion or the second monitoring occasion of the paging early indication information;
port information of the first reference signal;
a resource list of the first reference signal;
a repetition number of the first reference signal;
an effective delay of the first reference signal;
a transmission cycle of the first reference signal; and
an activation state of the first reference signal, where the activation state includes activation or deactivation.

Optionally, the paging early indication information or the paging message includes target indication information, and the target indication information is used for indicating at least one of the following:
the activation state of the first reference signal;
the offset information of the first monitoring occasion of the first reference signal; and
the repetition number of the first reference signal.

Optionally, the target indication information included in the paging early indication information is applied to the monitoring of a paging message associated with the paging early indication information.

Optionally, the first reference signal is a repeated transmission of the second reference signal.

Optionally, the paging early indication information is carried by downlink control information DCI or a low-power wake-up signal LP-WUS.

The paging processing apparatus in embodiments of this application may be an electronic device, for example, an electronic device having an operating system, or a component in an electronic device, such as an integrated circuit or a chip. The electronic device may be a terminal, or may be another device other than a terminal. For example, the terminal may include, but is not limited to, the types of the terminal 11 listed above, and the another device may be a server, a network attached storage (Network Attached Storage, NAS), or the like. This is not specifically limited in embodiments of this application.

The paging processing apparatus provided in embodiments of this application can implement all processes implemented in the method embodiments of FIG. 2 to FIG. 4, and can achieve the same technical effect. To avoid repetition, details are not described herein.

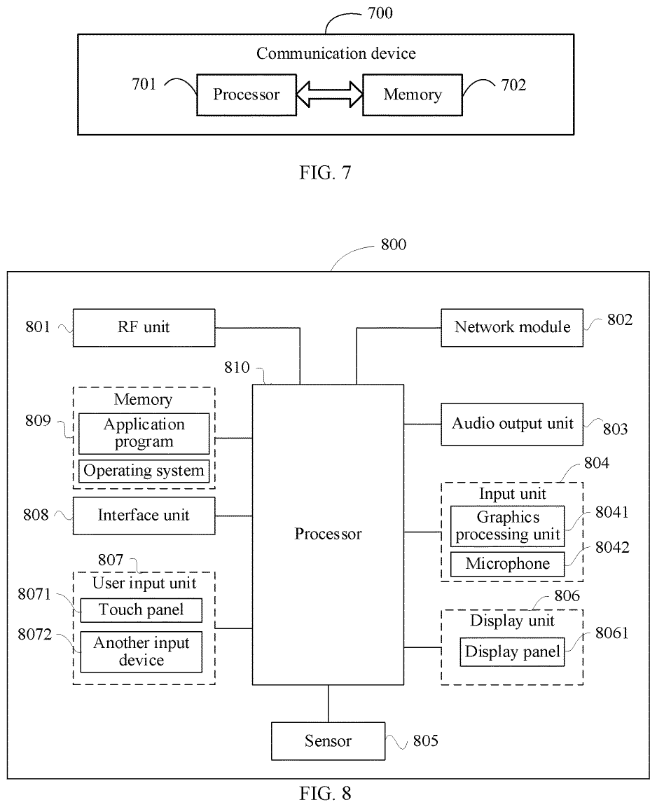

As shown in FIG. 7, embodiments of this application further provide a communication device 700, including a processor 701 and a memory 702. The memory 702 stores a program or instructions executable on the processor 701. The program or the instructions, when executed by the processor 701, implement the steps of the foregoing paging processing method embodiments, and can achieve the same technical effect. To avoid repetition, details are not described herein.

Embodiments of this application further provide a terminal, including a processor and a communication interface. The communication interface is coupled to the processor. The processor is configured to run a program or instructions, to implement the steps in the method embodiment shown in FIG. 2. The terminal embodiment corresponds to the foregoing method embodiment of the terminal side. Each implementation process and implementation of the foregoing method embodiments can be applied to the terminal embodiment, and can achieve the same technical effect. Specifically, FIG. 8 is a schematic diagram of a hardware structure of a terminal for implementing an embodiment of this application.

The terminal 800 includes but is not limited to at least some of components such as a radio frequency unit 801, a network module 802, an audio output unit 803, an input unit 804, a sensor 805, a display unit 806, a user input unit 807, an interface unit 808, a memory 809, and a processor 810.

A person skilled in the art may understand that the terminal 800 may further include a power supply (such as a battery) that supplies power to various components. The power supply may be logically connected to the processor 810 through a power management system, thereby implementing functions such as charging management, discharging management, and power consumption management through the power management system. The terminal structure shown in FIG. 8 constitutes no limitation on the terminal. The terminal may include more or fewer components than those shown in the figure, or some components may be combined, or a different component arrangement may be used. Details are not described herein.

It should be noted that, in embodiments of this application, the input unit 804 may include a graphics processing unit (Graphics Processing Unit, GPU) 8041 and a microphone 8042. The graphics processing unit 8041 processes image data of a static picture or a video obtained by an image capture apparatus (such as a camera) in a video capture mode or an image capture mode. The display unit 806 may include a display panel 8061. The display panel 8061 may be configured in a form such as a liquid crystal display or an organic light-emitting diode. The user input unit 807 includes at least one of a touch panel 8071 or another input device 8072. The touch panel 8071 is also referred to as a touch screen. The touch panel 8071 may include two parts: a touch detection apparatus and a touch controller. The another input device 8072 may include, but is not limited to, a physical keyboard, a function button (such as a volume control button or a power button), a trackball, a mouse, and a joystick. Details are not described herein.

In embodiments of this application, the radio frequency unit 801 receives downlink data from a network side device, and then may transmit the data to the processor 810 for processing. In addition, the radio frequency unit 801 may send uplink data to the network side device. Generally, the radio frequency unit 801 includes, but is not limited to, an antenna, an amplifier, a transceiver, a coupler, a low noise amplifier, a duplexer, and the like.

The memory 809 may be configured to store a software program or instructions and various data. The memory 809 may mainly include a first storage area for storing a program or instructions and a second storage area for storing data. The first storage area may store an operating system, an application program or instructions required for at least one function (such as a sound playback function and an image playback function), and the like. In addition, the memory 809 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 809 in embodiments of this application includes, but is not limited to, these and any other suitable types of memories.

The processor 810 may include one or more processing units. Optionally, an application processor and a modem processor are integrated into the processor 810. The application processor mainly processes operations related to an operating system, a user interface, an application program, and the like. The modem processor mainly processes a wireless communication signal, for example, may be a baseband processor. It may be understood that the foregoing modem processor may alternatively not be integrated into the processor 810.

The radio frequency unit 801 is configured to obtain configuration information of a first reference signal; and the monitoring module is configured to monitor the first reference signal based on the configuration information of the first reference signal, where
the first reference signal is used for at least one of the following:
assisting in monitoring paging early indication information; and
assisting in monitoring a paging message.

In embodiments of this application, because the first reference signal assists in at least one of monitoring of the paging early indication information and monitoring of the paging message, this can avoid a case in which an excessively large SSB cycle makes it impossible to support demodulation of the paging early indication information and the paging message. Therefore, embodiments of this application improve paging reliability.

It may be understood that for the implementation process of each implementation mentioned in this embodiment, reference may be made to the relevant description of the method embodiments of the terminal side, and the same or corresponding technical effect can be achieved. To avoid repetition, details are not described herein.

Embodiments of this application further provide a network side device, including a processor and a communication interface. The communication interface is coupled to the processor, and the processor is configured to run a program or instructions, to implement the steps of the method embodiment shown in FIG. 4. An embodiment of the network side device corresponds to the foregoing method embodiment of the network side device. Each implementation process and implementation of the foregoing method embodiment can be applied to this embodiment of the network side device, and can achieve the same technical effect.

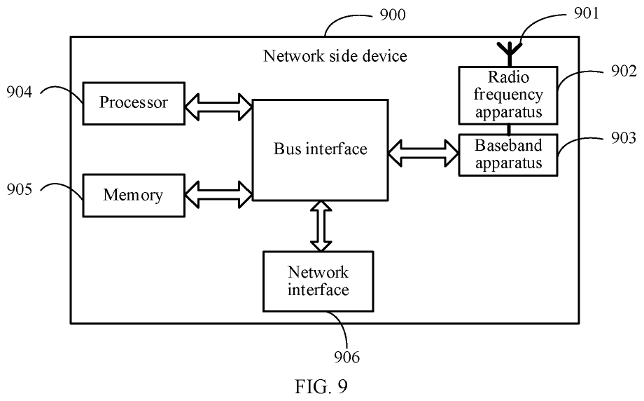

Specifically, embodiments of this application further provide a network side device. As shown in FIG. 9, the network side device 900 includes an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes to-be-sent information and sends the processed to-be-sent information to the radio frequency apparatus 902. The radio frequency apparatus 902 processes the received information and then sends the processed received information through the antenna 901.

The method performed by the network side device in the foregoing embodiments may be implemented in the baseband apparatus 903. The baseband apparatus 903 includes a baseband processor.

The baseband apparatus 903 may include, for example, at least one baseband board. The baseband board is provided with a plurality of chips. As shown in FIG. 9, one of the chips is, for example, a baseband processor and is connected to the memory 905 through a bus interface, to call a program in the memory 905 to perform the operations of the network side device shown in the foregoing method embodiments.

The network side device may further include a network interface 906. The interface is, for example, a common public radio interface (Common Public Radio Interface, CPRI).

Specifically, the network side device 900 in embodiments of this application further includes instructions or a program stored in the memory 905 and executable on the processor 904. The processor 904 calls the instructions or the program in the memory 905 to perform the method performed by each module shown in FIG. 6, and achieves the same technical effect. To avoid repetition, details are not described herein.

Embodiments of this application further provide a readable storage medium. The readable storage medium stores a program or instructions. The program or the instructions, when executed by a processor, implement the processes of the foregoing paging processing method embodiments, and can achieve the same technical effect. To avoid repetition, details are not described herein.

The processor is a processor in the terminal described in the foregoing embodiments. The readable storage medium includes a computer-readable storage medium, such as a computer read-only memory ROM, a random access memory RAM, a magnetic disk, or an optical disk. In some examples, the readable storage medium may be a non-transitory readable storage medium.

Embodiments of this application further provide a chip. The chip includes a processor and a communication interface. The communication interface is coupled to the processor. The processor is configured to run a program or instructions, to implement the processes of the foregoing paging processing method embodiments, and can achieve the same technical effect. To avoid repetition, details are not described herein.

It should be understood that the chip mentioned in embodiments of this application may be further referred to as a system level chip, a system chip, a chip system, a system on chip, or the like.

Embodiments of this application further provide a computer program/program product. The computer program/program product is stored in a storage medium. The computer program/program product is executed by at least one processor to implement the processes of the foregoing paging processing method embodiments, and can achieve the same technical effect. To avoid repetition, details are not described herein.

Embodiments of this application further provide a wireless communication system, including a terminal and a network side device. The terminal may be configured to perform the steps of the foregoing paging processing method of the terminal side, and the network side device may be configured to perform the steps of the foregoing paging processing method of the network side device.

It should be noted that a term “comprise”, “include” or any other variant herein is intended to encompass non-exclusive inclusion, so that a process, a method, an article, or an apparatus including a series of elements not only includes those elements, but also includes another element not listed explicitly, or includes intrinsic elements for the process, the method, the article, or the apparatus. Without any further limitation, an element defined by the phrase “include one” does not exclude existence of an additional same element in the process, the method, the article, or the apparatus that includes the element. In addition, it should be noted that the scope of the method and the apparatus in implementations of this application is not limited to function execution in the order shown or discussed, and may further include function execution in a substantially simultaneous manner or in the opposite order based on the functions involved. For example, the described method may be performed in an order different from the described order, and various steps may further be added, omitted, or combined. Moreover, features described with reference to some examples may be combined in another example.

Through the descriptions of the foregoing implementations, a person skilled in the art may clearly learn that the method in the foregoing embodiments may be implemented by a computer software product with a necessary universal hardware platform, or may be implemented by hardware. The computer software product is stored in a storage medium (such as a ROM, a RAM, a magnetic disk, or an optical disc) and includes several instructions, to enable a terminal or a network side device to perform the method described in embodiments of this application.

Although embodiments of this application are described above with reference to the accompanying drawings, this application is not limited to the foregoing specific implementations. The foregoing specific implementations are illustrative only but not restrictive. With the enlightenment of this application, a person of ordinary skill in the art may make many forms of implementations without departing from the concept of this application and the protection scope of the claims. These implementations fall within the protection scope of this application.

What is claimed is:

1. A paging processing method, comprising:
obtaining, by a terminal, configuration information of a first reference signal; and
monitoring, by the terminal, the first reference signal based on the configuration information of the first reference signal, wherein
the first reference signal is used for at least one of the following:
assisting in monitoring paging early indication information; and
assisting in monitoring a paging message.

2. The method according to claim 1, wherein the first reference signal is further used for at least one of the following:
mobility measurement; cell selection; selection of a random access resource; switching of a transmission reception point (TRP); switching of a TRP group; beam failure detection; beam management; link failure detection; positioning; activation of another reference signal or channel; deactivation of another reference signal or channel; path loss estimation; power control; and power distribution.

3. The method according to claim 1, wherein the configuration information of the first reference signal comprises information indicating whether the first reference signal is enabled, and the monitoring, by the terminal, the first reference signal based on the configuration information of the first reference signal comprises:
monitoring, by the terminal, the first reference signal based on the configuration information of the first reference signal when the first reference signal is enabled.

4. The method according to claim 1, wherein a first monitoring occasion of the first reference signal satisfies at least one of the following:
the first monitoring occasion is located before a second monitoring occasion of the paging early indication information, and a time interval between the first monitoring occasion and the second monitoring occasion is less than or equal to a first time interval;
the first monitoring occasion is located between the second monitoring occasion of the paging early indication information and a paging occasion associated with the paging early indication information;
the first monitoring occasion is located after the second monitoring occasion of the paging early indication information, and a time interval between the first monitoring occasion and the second monitoring occasion is less than or equal to a second time interval;
the first monitoring occasion is located after the second monitoring occasion of the paging early indication information, and a time interval between the first monitoring occasion and the second monitoring occasion is larger than a third time interval; and
the first monitoring occasion is located before the paging occasion, and a time interval between the first monitoring occasion and the paging occasion is less than or equal to a fourth time interval.

5. The method according to claim 1, wherein the first reference signal satisfies at least one of the following:
a structure of the first reference signal is at least partially consistent with a structure of a second reference signal; and
relative position relationships of time-frequency resources of components of the first reference signal are at least partially consistent with relative position relationships of time-frequency resources of components of the second reference signal, wherein
the second reference signal comprises a synchronization signal block (SSB) or a tracking reference signal (TRS).

6. The method according to claim 1, wherein the configuration information of the first reference signal comprises at least one of the following:
a signal type of the first reference signal;
an association relationship between the first reference signal and the second reference signal;
time-frequency domain position information of the first reference signal;
offset information of the first monitoring occasion of the first reference signal, wherein the offset information is used for representing offset information of the first monitoring occasion relative to a target occasion, and the target occasion comprises the paging occasion or the second monitoring occasion of the paging early indication information;
port information of the first reference signal;
a resource list of the first reference signal;
a repetition number of the first reference signal;
an effective delay of the first reference signal;
a transmission cycle of the first reference signal; and
an activation state of the first reference signal, wherein the activation state comprises activation or deactivation.

7. The method according to claim 1, wherein a method of obtaining the configuration information of the first reference signal comprises at least one of the following:
configured by high layer information of a network side device;
specified by a protocol; and
indicated by physical layer signaling or a signal.

8. The method according to claim 1, wherein the paging early indication information or the paging message comprises target indication information, and the target indication information is used for indicating at least one of the following:
the activation state of the first reference signal;
the offset information of the first monitoring occasion of the first reference signal; and
the repetition number of the first reference signal.

9. The method according to claim 8, wherein the target indication information comprised in the paging early indication information is applied to the monitoring of a paging message associated with the paging early indication information.

10. The method according to claim 1, wherein the monitoring, by the terminal, the first reference signal based on the configuration information of the first reference signal comprises:
monitoring, by the terminal, the first reference signal based on the configuration information of the first reference signal when the second reference signal between the second monitoring occasion of the paging early indication information and the paging occasion of the paging message associated with the paging early indication information satisfies a first preset condition, wherein
the first preset condition comprises at least one of the following:
a number of second reference signals is less than or equal to a first preset threshold; and
a number of second reference signals with the measured values being greater than or equal to a second preset threshold is less than or equal to a third preset threshold.

11. The method according to claim 1, further comprising:
determining, by the terminal, not to monitor the first reference signal on the first monitoring occasion of the first reference signal when a second preset condition is satisfied, wherein
the second preset condition comprises at least one of the following:
the paging early indication information indicates not to monitor the paging message; and
the second reference signal between the second monitoring occasion of the paging early indication information and the paging occasion of the paging message associated with the paging early indication information satisfies the first preset condition, wherein
the first preset condition comprises at least one of the following: the number of second reference signals is greater than the first preset threshold; and a number of second reference signals with the measured values being greater than or equal to a second preset threshold is greater than a third preset threshold.

12. The method according to claim 1, wherein the first reference signal is a repeated transmission of the second reference signal.

13. The method according to claim 1, wherein the paging early indication information is carried by downlink control information (DCI) or a low-power wake-up signal (LP-WUS).

14. A paging processing method, comprising:
sending, by a network side device, a first reference signal, wherein
the first reference signal is used for at least one of the following:
assisting in monitoring paging early indication information; and
assisting in monitoring a paging message.

15. The method according to claim 14, wherein the sending, by a network side device, a first reference signal comprises:
sending, by the network side device, the first reference signal when a second reference signal between a second monitoring occasion corresponding to the paging early indication information and a paging occasion associated with the paging early indication information satisfies a first preset condition.

16. The method according to claim 14, further comprising:
sending, by the network side device, configuration information of the first reference signal to a terminal.

17. The method according to claim 14, wherein the first reference signal is further used for at least one of the following:
mobility measurement; cell selection; selection of a random access resource; switching of a transmission reception point (TRP); switching of a TRP group; beam failure detection; beam management; link failure detection; positioning; activation of another reference signal or channel; deactivation of another reference signal or channel; path loss estimation; power control; and power distribution.

18. The method according to claim 14, wherein the configuration information of the first reference signal comprises information indicating whether the first reference signal is enabled.

19. A terminal, comprising a processor and a memory, wherein the memory stores a program or instructions executable on the processor, and the program or the instructions, when executed by the processor, implement a paging processing method comprising:
obtaining configuration information of a first reference signal; and
monitoring the first reference signal based on the configuration information of the first reference signal, wherein
the first reference signal is used for at least one of the following:
assisting in monitoring paging early indication information; and
assisting in monitoring a paging message.

20. A network side device, comprising a processor and a memory, wherein the memory stores a program or instructions executable on the processor, and the program or the instructions, when executed by the processor, implement the steps of the paging processing method according to claim 14.
